(19) United States
(12) Patent Application Publication
(10) Pub. No.: US 2023/0195099 A1
(43) Pub. Date: Jun. 22, 2023

(54) METHOD AND SYSTEM FOR OPTIMIZING SERVICING OF INDUSTRIAL MACHINES

(71) Applicant: Siemens Aktiengesellschaft, 80333 München (DE)

(72) Inventor: JENS SCHNITTGER, Lonnerstadt (DE)

(73) Assignee: Siemens Aktiengesellschaft, 80333 München (DE)

(21) Appl. No.: 17/802,385

(22) PCT Filed: Feb. 9, 2021
(86) PCT No.: PCT/EP2021/053060

§ 371 Date: Aug. 25, 2022

(30) Foreign Application Priority Data
Feb. 26, 2020 (EP) 20159493.4

(51) Int. Cl. G05B 23/02

(52) U.S. Cl. CPC G05B 23/0283

(57) ABSTRACT

A method for numerically optimizing service intervals for at least one component of an Industrial machine is disclosed. The component is exposed to a time-dependent load. A failure behaviour is described by a failure rate and the failure rate is in the form of a function of a load integral. Failure rate measurement data of the component are provided for at least one predefined load. A function is defined fitting of the failure rate measurement data. A load integral is calculated. Failure behaviour is calculated on the basis of the predefined function and the calculated load integral. The calculated failure behaviour is taken as a basis for calculating at least one optimized service Interval.

The invention relates to a computer-implemented method for numerically optimizing service intervals for at least one component of an industrial machine.

The invention also relates to a method for servicing at least one component of an Industrial machine according to the service intervals which have been determined by means of the cited optimization method.

Moreover, the invention relates to a data processing system, comprising means for executing the steps of the method for numerically optimizing service intervals of the afore-cited type.

Furthermore, the invention relates to a system comprising at least one industrial machine having at least one component and a data processing system of the afore-cited type.

In addition, the invention relates to a computer program, comprising commands which, when the program is executed by a computer, trigger this to execute the steps of the method of the afore-cited type, and to a computer-readable data carrier, on which one such computer program is stored, and a data carrier signal, which transmits the computer program of the afore-cited type.

Currently when industrial machines are serviced, it is assumed that the load is time-independent. For a constant predetermined load, a servicing frequency can be calculated on the basis of experimental statistics or design Information. In the case of the afore-cited constant loading, a maximum number of hours during which the component of the industrial machine or the industrial machine is permitted to be used without servicing is often specified.

A disadvantage of such a service planning consists in the use depending substantially on the load under which the component or the Industrial machine finds itself. However, this load may depend on a specific usage scenario and vary over time. The assumption of a constant load (current load) may therefore result in a significant over- or underestimation of the service intervals. This may in turn lead to an increased failure rate or increased service costs.

A further disadvantage results in that the failure rate is determined by loading-independent aging and by loading-dependent wear. Heuristic failure rate distributions, such as e.g. Weibull statistics, can be used to model this complicated behavior. In this regard the parameters of the failure rate distributions are determined on the basis of failure statistics collected in the past with a predetermined constant load and are no longer changed after said determination. This results in the failure rate distributions determined in this way only applying to this predetermined constant load. If the working load of the industrial machine is now changed, this in turn results either in increased failures and costly downtimes or in increased service costs.

The object of the present invention consists in configuring the use of the industrial machines more efficiently and at the same time in reducing their maintenance costs.

The object is achieved in accordance with the invention with a computer-implemented method of the afore-cited type in that
A) the (future or forecast) failure behavior of the at least one component is described by a failure rate p_{ƒ}(t|S) (“S” stands for “survival”; t stands for time), wherein the failure rate is embodied as a function ƒ of a load integral L(t);
B) failure rate measurement data of the at least one component is provided for at least one predetermined loading;
C) the function Is defined by means of adjusting or by means of fitting the failure rate measurement data;
D) the load integral is calculated on the basis of a load of the at least one component, said load being planned for the future and varying during operation of the component;
E) the (future or forecast) failure behavior (statistics) is calculated on the basis of the defined function and the calculated load integral;
F) at least one service Interval is calculated on the basis of the failure behavior calculated (for the future).

Step A) can be considered as a definition of a frame which is used in the further method. In order to calculate the forecast failure behavior, the function and the load integral must be determined in the further steps.

In steps B) and C), the function is defined on the basis of the (historical) failure rate measurement data, which was recorded with a predetermined, for instance constant or piecewise constant loading.

In step D), the load integral is calculated on the basis of the forward-looking load data relating to the at least one component. It is assumed here that in the future the component is operated under a load which varies (over time).

The fact that in step E) a failure statistic is calculated on the basis of the load integral calculated with the aid of the forward-looking load data relating to the at least one component means that the service Interval is optimized; this is determined on the basis of this (forward-looking) failure statistic.

Any measurement data which can be obtained by measuring the failure rate of the component with the predetermined loading is understood to mean the failure rate measurement data of the component for a predetermined loading. Such failure measurements often produce a failure probability with a bathtub-shaped profile.

The adjustment/fitting of the failure rate measurement data is understood here to mean an adjustment calculus, for Instance regression, maximum likelihood etc. for failure rate measurement data.

In conjunction with the present invention, the term load integral is understood to mean an integral of a loading function—also current loading or current load, over time.

The failure rate p_{ƒ}(t|S) is associated by definition with the survival function pₛ(t) (“S” stands for “survival”) as follows:

$${ρ}_{f} ( t \vert S ) = - \frac{{p}_{s}^{′} ( t )}{{p}_{s} ( t )} \qquad ( 1 )$$

The relation in respect of the failure probability density p_{ƒ}(t) (with pₛ(t)=1−∫₀^{t}dt′ρ_{ƒ}(t′))

is provided by

ρ_{ƒ}(t)=ρ_{ƒ}(t|S)pₛ(t) (2)

The failure rate in step A of the afore-cited method is provided by the following equation:

$${ρ}_{f} ( t \vert S ) = - \frac{{p}_{s}^{′} ( t )}{{p}_{s} ( t )} = f ( L ( t ) ) \qquad ( 3 )$$

Here the function ƒ is a fixed but arbitrary function, which assumes (non-negative) realistic values.

Such a dependency of the failure rate on the load integral corresponds to those situations in which the failure probability is determined by the wear state, wherein the wear state itself is determined by the cumulative loading. The concept of the wear state Is understood here in a very general sense to mean where e.g, a loading-independent aging is also subsumed.

It is absolutely conceivable for the load integral L(t) to be a vector. If L(t) is a vector, this means that different “loading-type” criteria can firstly be taken into account separately, wherein different components of the L(t) vector can describe different criteria, e.g. torque and rotational speed requested in the case of a motor.

For the sake of simplicity, the case of scalar loading is discussed below, wherein the following statements apply mutatis mutandis to the general case of a vectorial loading.

There Is often the situation that a predetermined vectorial cumulative loading (L(t)) can be transformed with the aid of physical considerations by an already known function into a scalar cumulative loading L(t) (more precisely: into a wear state which results from all loading components together). In this case, with the load integral L(t) in equation (3) a scalar function can further be assumed.

A particularly rapid adjustment/fitting can be enabled if the at least one loading is a constant or a piecewise constant loading.

In conjunction with the present invention, the term “loading” or “loading function” is understood to mean a current loading, also known as current loading or current load. Conversely, the term cumulative loading, or load Integral, refers to a current load which is integrated over time. E.g. with a constant loading l for the load integral the result l*t is produced, however, periodic loading functions are also just as conceivable, for instance.

With respect to the accuracy of the adjustment, it may be useful if the failure rate measurement data of the component is provided for two or more predetermined, preferably different loadings. It may be e.g. different constant loadings.

Particularly good results can be achieved if the function ƒ (x) is embodied as an at least one-parameter family of preferably constant probability distributions, in particular as a multi-parameter, for instance three-parameter modified Weibull distribution.

The three-parameter modified Weibull distribution is provided by a failure rate of the type (see “Extended Weibull distributions in reliability engineering”, Tang Yong, National University of Singapore, PhD thesis 2004. http-/scholarbank.nus.sq/bitstream/handle/10635/14186/TangY.pdf?sequence=1):

ƒ(x)=α′(b′+λ′x)x^{b′-1}e^{λ′x} (4)

In the direct application of equation (4), i.e. without its adjustment for non-constant loading curves—for the description of failure rates, x corresponds to the time and Is known from the prior art (see cited doctoral thesis).

In accordance with the Invention, the failure rate is embodied as a function ƒ of a load Integral L(t)—(see equation (3)), so that with the described example, in which the function ƒ is embodied as the three-parameter modified Weibull distribution according to equation (4), x equates to the cumulative loading L(t).

The function shown in equation (4) provides a very good description of the failure probabilities or failure rates which were received with a constant loading l (such failure rate measurement data can have a bathtub-shaped curve, for instance). This results in

ρ_{ƒ}(t|S)=α(b+λt)t^{b-1}e^{λt}=ƒ(lt) (5)

and

α′=αl^{-b+},b′:=b,λ′:=λ/l,

Here the parameters a, b and λ are determined in a loading-dependent manner according to the specified formula, whereas α′, b′ and λ′ are independent of |; their values can be determined when fitted to the specific measurement data.

Provision can therefore be made in one embodiment for the parameters of the function ƒ(x) to be determined by means of the maximum likelihood method when the function ƒ(x) is defined by fitting the failure rate measurement data.

The load integral or the loading function can define a degradation state of the component of the industrial machine, for instance. In this regard when the load integral or the loading function is specified or defined, the effects of aging (“aging effects”), fatigue, wear etc. can be accommodated.

The load integral can be calculated for instance on the basis of an exemplary future work schedule of the industrial machine, in which the (planned) working load of the component of the machine is described.

As soon as the function ƒ(x), as already described in the introduction, has been defined on the basis of historical failure rate measurement data, the load integral L(t) can be calculated/defined for the future and used in the equation (3), in order to calculate the statistics of the failure behavior for the future and thus to be able to forecast the future failure rates.

On the basis of this forecast (failure rates calculated in the future), at least one service Interval or more, preferably all service Intervals, can now be numerically optimized for the at least one component of an industrial machine. Here one or more statistical variables (parameters) can (but need not) be calculated from the failure rates as required, in order to calculate the optimized service intervals or service interval lengths on this basis.

On the basis of optimized service intervals, the production can be controlled/optimized accordingly within one or more industrial installations, by an operator or a system described below manually or automatically stopping industrial machine(s) within the industrial Installation(s) at a point in time which is calculated according to the optimized service intervals, whereupon the service process then follows. It should be noted at this point that the failure rate measurements of the component, which result in failure rate measurement data, are typically also carried out with the afore-cited method for numerical optimization of service intervals, with predetermined service interval lengths. For instance, the predetermined (not optimized) service interval lengths may all be the same, i.e. defined/prescribed by the manufacturer of the component.

Since the calculated statistics of the failure behavior depends on the calculated, e.g. planned load integral, the optimized service intervals are loading-dependent.

For instance, the failure rate measurements can be collected with at least one predetermined loading and with predetermined service interval lengths.

In one embodiment, provision can advantageously be made for the (loading-dependent) service intervals to be preventative maintenance intervals, in particular cost-effective preventative maintenance intervals.

A cost-effective precautionary service interval Tₒₚₜ can be calculated for instance with the aid of the following equation (see e.g. “Ingénierie de la maintenance: De la conception á l'exploitation d'un bien” [“Maintenance engineering: from the design to the operation of an asset” ]. Jean-Claude Francastel; Dunod, L'Usine Nouvelle 2009 (2nd edition), Chapter 5.3:

$$\frac{\partial }{\partial T} \vert {T}_{opt} {〈 C 〉}_{∞} = 0 \qquad ( 6 )$$

$$wherein :$$

$${〈 C 〉}_{∞} := {lim}_{t \to ∞} \frac{〈 c ( t ) 〉}{t} = \frac{{c}_{p} {p}_{p} + {c}_{u} ( 1 - {p}_{p} )}{{\int }_{0}^{t} {dt}^{′} {p}_{s} ( {t}^{′} )}$$

cₚ and cᵤ are service costs which develop during a planned or an unplanned service event, and

pₚ=pₛ(T)

pₛ(t):=1−∫₀^{t}dt′ρ_{ƒ}(t′)

Since the calculated failure rate is loading-dependent, the cost-effective preventative maintenance intervals are likewise loading-dependent.

In conjunction with the present invention, the term service interval of a component is understood to mean a time Interval between the commissioning of the component and the first scheduled/precautionary service or between two scheduled services. In this regard this type of service is not to be mistaken for a repair, since a repair is a corrective service.

Furthermore, provision can advantageously be made for
G) further failure rate measurement data to be collected for the at least one optimized service interval, and
E) the steps A to F to be repeated, wherein the failure rate measurement data in step A additionally comprises the further failure rate measurement data.

By recording the failure rate measurement data, which was collected with the already optimized service interval lengths, the optimization of service interval lengths can be successively further Improved as input failure rate measurement data.

The object of the invention is moreover achieved with a method for servicing at least one component of an industrial machine in that for the at least one component of the industrial machine, at least one, preferably more, in particular all service intervals are optimized as described above and the at least one component is serviced according to the optimized service intervals.

It may be expedient if reaching the end of the service Interval is signaled to an operator of the industrial machine, in particular in the form of a warning and/or when an optimized service interval (scheduled service not carried out) is exceeded, the at least one component and/or the industrial machine is automatically switched off by an operator or by a system described below.

The object of the Invention is moreover achieved with a data processing system, which comprises means for executing the steps of the afore-described computer-implemented method for optimizing service intervals of at least one component of an industrial machine.

The object of the invention is moreover achieved with a computer program, which comprises commands which, when the program is executed by a computer, trigger this to execute the steps of the afore-cited method for optimizing service intervals.

In this respect this computer program can be part of the data processing system, as it can be stored and executed on a computer, e.g. a server, of the data processing system.

The object of the invention is moreover achieved with a system comprising at least one Industrial machine having at least one component and a previously described data processing system. In this regard the data processing system is designed to exchange data with the at least one Industrial machine, in order to collect or receive in particular failure rate measurement data of the component for at least one predetermined loading and to implement the optimized service intervals on the industrial machine.

With one embodiment, provision can be made for the system to be automated and designed for instance to automatically switch off the corresponding component and/or the industrial machine when service intervals are exceeded (scheduled servicing is not carried out).

The invention plus further advantages Is explained in more detail below on the basis of exemplary embodiments, which are illustrated in the drawing. The drawings show:

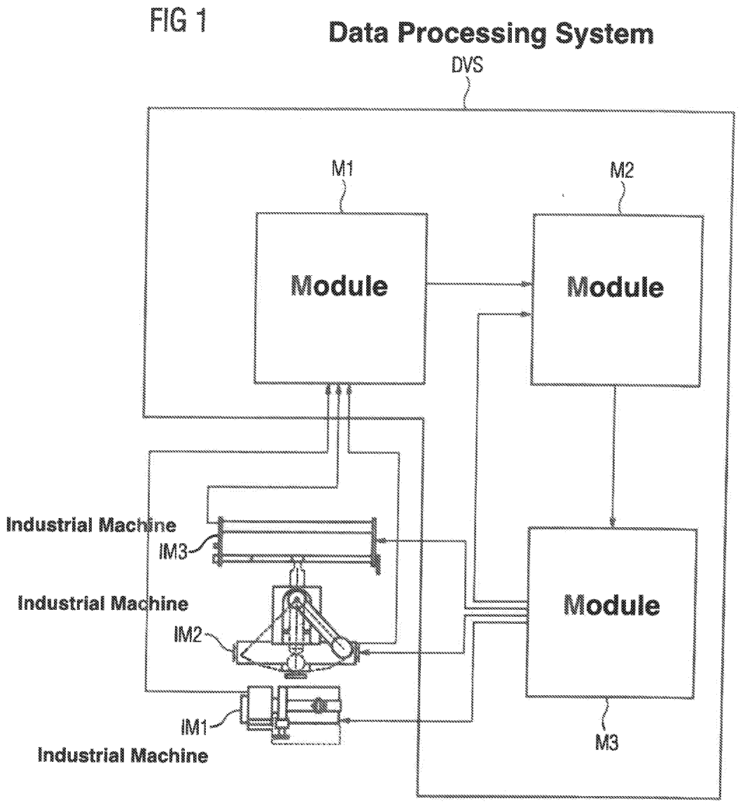

FIG. 1 an industrial environment with a number of industrial machines, the service intervals of which can be optimized, and

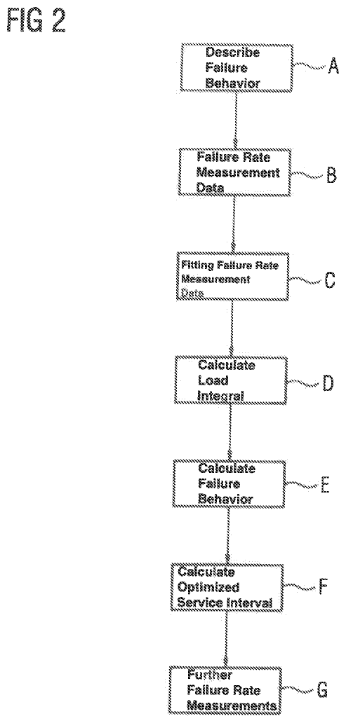

FIG. 2 a flow chart of a method for optimizing service intervals.

Reference is firstly made to FIG. 1. FIG. 1 shows in particular a data processing system DVS, which interacts with a number of industrial machines IM1, IM2, IM3 and can exchange data. For instance, the data processing system DVS can comprise a number of modules—for Instance a first M1, a second M2 and a third module M3, which can fulfill a series of specific tasks in each case.

It should be noted at this point that the data processing system DVS can comprise a combination of software and hardware components.

The first module M1 can be designed for instance to receive data, e.g. failure rate measurement data from the industrial machines IM1, IM2, IM3 (step B), to store and process these. For instance, the first module M1 can be designed to fit the failure rate measurement data and to determine a function ƒ on the basis of this calculation (step C).

The failure rate measurement data can have a course with a bathtub-shaped profile. Here the first module M1 can fit the bathtub-shaped curves with a three-parameter modified Welbull distribution and determine the three parameters a′, b′ and λ′ which define the three-parameter modified Weibull distribution. As mentioned in the introduction, the three-parameter modified Weibull distribution is particularly well suited to the case when operating conditions correspond to a constant loading or a piecewise constant loading.

In order to approach the failure rate measurement data, it may be advantageous if the failure rate measurement data of the component is provided for WO2021/170392 PCT/EP2021/053060 two or more predetermined, preferably different loadings. In this case, the data processing systems DVS, here by means of the first module M1, can increase the accuracy of the equalization method, e.g. of the fitting, because there is more measurement data, and more accurately determine the parameters a′, b′ and λ′ for instance.

The second module M2 can be designed for instance to calculate a load integral L(t), which is to be used when the failure behavior of the components of the industrial machines IM1, IM2, IM3 is calculated, in other words in step E, and thus to execute step D. The (future) work schedules for the calculation of a time-dependent load and the load integral can be formulated for example by the third module M3 and made available to the second module M2 or transmitted to the second module M2. In this regard the third module M3 determines work schedules, e.g. information relating to the use of the industrial machines IM1, IM2, IM3 for the coming weeks/two weeks/the coming month. The work schedules can be determined on the basis of predetermined (nonoptimized) service intervals. The third module M3 then sends these (not-optimized) work schedules to the second module M2, so that the second module M2 can calculate the time-dependent load and the load integral L (t) (execution of step D).

The regulation to calculate the failure rate ρ(t|S) as a function ƒ of the load integral L(t) can exist, e.g. be stored, in the second module M2, for instance. Here the function ƒ with the regulation present in the second module M2 Is not known a priori (regulation with an unknown function which is first to be defined). In the present example, the function ƒ is defined/determined by means of the first module M1 and transmitted to the second module M2, e.g. In the form of three parameters a′, b′ and λ′. The second module M2 can then execute step E and the failure rate ρ(t|S) on the basis of the function ƒ and the load integral L(t) (equation (3)).

The equation (3) applies to any load integrals L(t) and thus to any operating conditions of the industrial machines IM1, IM2, IM3 which vary over time.

Service intervals can be optimized on the basis of the now calculated failure behavior (step F). This can be executed by means of the second module M2, for instance.

As already mentioned, the third module M3 takes the service intervals into account when the work schedules are formulated. E.g. the third module M3 can formulate work schedules as a function of the optimized service intervals, which can obtain (is made available or transmitted to) the third module M3 from the second module M2.

The third module M3 is preferably further designed to implement the work or production plans (including service plans) formulated (on the basis of the optimized service intervals), by it correspondingly controlling the industrial machines IM1, IM2, IM3 or triggering a corresponding control of the industrial machines IM1, IM2, IM3, for instance. It can either occur automatically or with the aid of an operator.

It should be noted at this point that the modules M1, M2, M3 can exist in the form of a hardware or/and software, e.g. be embodied as parts of a software program. They can (but need not) also be embodied as structurally separate computing units, which are equipped with means which are configured to carry out the functions described here.

The data processing system DVS can make the user of the industrial machines IM1, IM2, IM3 aware of an imminent service, by signaling this to the user, for instance. The signaling can proceed in the form of repetitive audio and/or video signals, wherein the frequency of the signals can be increased, the closer the imminent service appointment gets.

Further failure rate measurements can optionally be carried out after Implementing the optimized service plan in order to obtain further failure rate measurement data (step G). The further failure rate measurement data can be used to improve the optimization, by the steps A to F being repeated, wherein the further failure rate measurement data is used as part of the input failure rate measurement data in step A (step E).

Based on the optimized service intervals, the production of an automated industrial system can be optimized, for instance. This can take place for instance by implementing (optimized) work schedules determined with the aid of the optimized service intervals. The implementation can take place automatically or with the aid of operating personnel by means of a system which is superior to the industrial installation.

FIG. 2 shows flow charts of a computer-implemented method for optimizing service intervals.

According to FIG. 2, the failure behavior is described in step A by a failure rate, wherein the failure rate is embodied as a function of a load integral. In step B, failure rate measurement data of the component is provided for at least one predetermined loading. In step C, the function is fixed by means of fitting the failure rate measurement data. In step D, the load integral is calculated (for instance on the basis of a future operating plan). In step E, the failure behavior is calculated on the basis of the defined function and the calculated load integral. In step F, an optimized service interval derived therefrom is calculated.

Optionally, in step G, further failure rate measurements can be carried out for the at least one optimized service interval, in order to obtain further failure rate measurement data, wherein steps A to F are repeated in step E, wherein the failure rate measurement data in step A additionally comprises the further failure rate measurement data.

In summary, the invention relates to methods and systems in which the servicing of components and thus servicing of one or also more industrial Installations can be optimized.

It is evident that alterations and/or additions of parts to the previously described methods and systems may take place without deviating from the field and scope of the present Invention. Likewise, it is evident that although the invention has been described in relation to specific examples, a person skilled in the art would certainly be in a position to obtain many other corresponding forms of the method and system, which have the properties presented in the claims and thus all fall within the protective scope specified thereby.

The reference characters in the claims merely serve to better understand the present invention and do not in any case signify a restriction of the present invention.

1.-14. (canceled)

15. A method for numerically optimizing service intervals of at least one component of an industrial machine, said method comprising the steps of:
A) describing a failure behavior of the at least one component by a failure rate, the failure rate embodied as a function of a load integral;
B) providing failure rate measurement data of the at least one component for at least one predetermined loading;
C) defining the function by fitting the failure rate measurement data;
D) calculating a load integral based on a load of the at least one component, the load being planned for the future and varying during operation of the at least one component;
E) calculating failure behavior based on the defined function and the calculated load integral; and
F) calculating at least one service interval based on the calculated failure behavior.

16. The method of claim 15, wherein the at least one predetermined loading is a constant or a piecewise constant loading.

17. The method of claim 15, wherein the failure rate measurement data of the at least one component is provided for two or more predetermined loadings.

18. The method of claim 15, wherein the function is embodied as an at least one-parameter family of probability distributions.

19. The method of claim 15, wherein when parameters of the function are determined by a maximum likelihood method.

20. The method of claim 15, wherein the load Integral is calculated from a work schedule of the industrial machine.

21. The method of claim 15, wherein the at least one service interval comprises predictive maintenance intervals.

22. The method of claim 15, further comprising:
G) carrying out further failure rate measurements for the at least one optimized service interval in order to obtain further failure rate measurement data, and
H) repeating the steps A to F, wherein the failure rate measurement data in step A additionally comprises the further failure rate measurement data.

23. A method for servicing at least one component of an Industrial machine wherein for the at least one component of the industrial machine, at least one service interval as set forth in in claim 15 is optimized and the at least one component is serviced according to the at least one service interval, wherein reaching an end of the at least one service interval is signaled to a user of the industrial machine.

24. A data processing system, comprising means for executing the steps of a method as set forth in claim 15.

25. A system comprising at least one Industrial machine with at least one component and one data processing system as set forth in claim 24, wherein the data processing system is designed to exchange data with the at least one industrial machine in order to collect failure rate measurement data of the at least one component for a least one predetermined loading and to implement optimized maintenance intervals on the Industrial machine.

26. A computer program product, comprising a program with commands which, when the program is executed by a computer, prompt said computer to carry out the steps of a method as set forth in claim 15.

27. A computer-readable data carrier on which the computer program set forth in claim 26 is stored.

28. A data carrier signal which transmits the computer program set forth in claim 26.

29. The method of claim 18, wherein the at least one-parameter family comprises constant probability distributions.

30. The method of claim 29, wherein the at least one-parameter family is multi-parameter.

31. The method of calm 30, wherein the multi-parameter family is a three-parameter modified Weibull distribution.

32. The method of claim 21, wherein the predictive maintenance intervals are cost-effective preventative maintenance intervals.

33. The method of claim 23, further comprising signaling the user with a warning upon reaching the end of the at least one service interval.

34. The method of claim 23, further comprising switching off the at least one component and/or the industrial machine when the at least one service Interval is exceeded.
